(19) United States
(12) Patent Application Publication
(10) Pub. No.: US 2013/0189523 A1
(43) Pub. Date: Jul. 25, 2013

(54) POLYIMIDE RESIN FILM, TUBULAR OR SUBSTANTIALLY TUBULAR MEMBER, TUBULAR MEMBER UNIT, INTERMEDIATE TRANSFER MEMBER, IMAGE-FORMING APPARATUS, AND METHOD FOR FORMING IMAGE

(71) Applicants: Tomotake INAGAKI, Kanagawa (JP); Tomoo MATSUSHIMA, Kanagawa (JP); Shigeru FUKUDA, Kanagawa (JP)

(72) Inventors: Tomotake INAGAKI, Kanagawa (JP); Tomoo MATSUSHIMA, Kanagawa (JP); Shigeru FUKUDA, Kanagawa (JP)

(73) Assignee: FUJI XEROX CO., LTD., Tokyo (JP)

(21) Appl. No.: 13/547,295

(22) Filed: Jul. 12, 2012

(30) Foreign Application Priority Data
Jan. 19, 2012 (JP) 2012-009416

(51) Int. Cl. B32B 9/04; C08K 5/00; G03G 15/01

(52) U.S. Cl. 428/411.1; 524/308; 399/302

(57) ABSTRACT

A polyimide resin film includes a layer containing a polyimide resin, fluoropolymer particles, and a compound represented by general formula (II) or a laminate of two or more layers including the layer as an outermost layer:

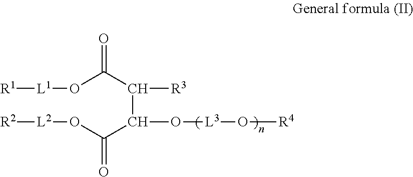

(wherein R¹ and R² are each independently a fully fluorinated linear or branched alkyl or a partially fluorinated linear or branched alkyl; R³ is hydrogen, methyl, or ethyl; R⁴ is hydrogen or a linear or branched alkyl; L¹ and L² are each independently a single bond or a linear or branched alkylene; L³ is a linear or branched alkylene; and n is an integer of about 5 to about 500).

### CROSS-REFERENCE TO RELATED APPLICATIONS

This application is based on and claims priority under 35 USC 119 from Japanese Patent Application No. 2012-009416 filed Jan. 19, 2012.

### BACKGROUND

### Technical Field

The present invention relates to polyimide resin films, tubular or substantially tubular members, tubular member units, intermediate transfer members, image-forming apparatuses, and methods for forming an image.

### SUMMARY

According to an aspect of the invention, there is provided a polyimide resin film including a layer containing a polyimide resin, fluoropolymer particles, and a compound represented by general formula (II) or a laminate of two or more layers including the layer as an outermost layer:

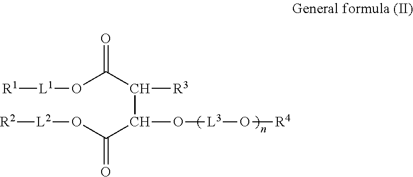

(wherein R¹ and R² are each independently a fully fluorinated linear or branched alkyl or a partially fluorinated linear or branched alkyl; R³ is hydrogen, methyl, or ethyl; R⁴ is hydrogen or a linear or branched alkyl; L¹ and L² are each independently a single bond or a linear or branched alkylene; L³ is a linear or branched alkylene; and n is an integer of about 5 to about 500).

### BRIEF DESCRIPTION OF THE DRAWINGS

Exemplary embodiments of the present invention will be described in detail based on the following figures, wherein:

FIG. 1 is a schematic sectional view of a polyimide resin film according to an exemplary embodiment;

FIG. 2 is a schematic perspective view of a tubular or substantially tubular member according to the exemplary embodiment;

FIGS. 3A and 3B are a schematic plan view and a schematic sectional view, respectively, of an example of a circular probe;

FIG. 4 is a schematic perspective view of a tubular member unit according to the exemplary embodiment;

FIG. 5 is a schematic view of an image-forming apparatus according to the exemplary embodiment; and

FIG. 6 is a schematic view of an image-forming apparatus according to another exemplary embodiment.

### DETAILED DESCRIPTION

Exemplary embodiments will now be described in detail with reference to the drawings.

### Polyimide Resin Film and Tubular or Substantially Tubular Member

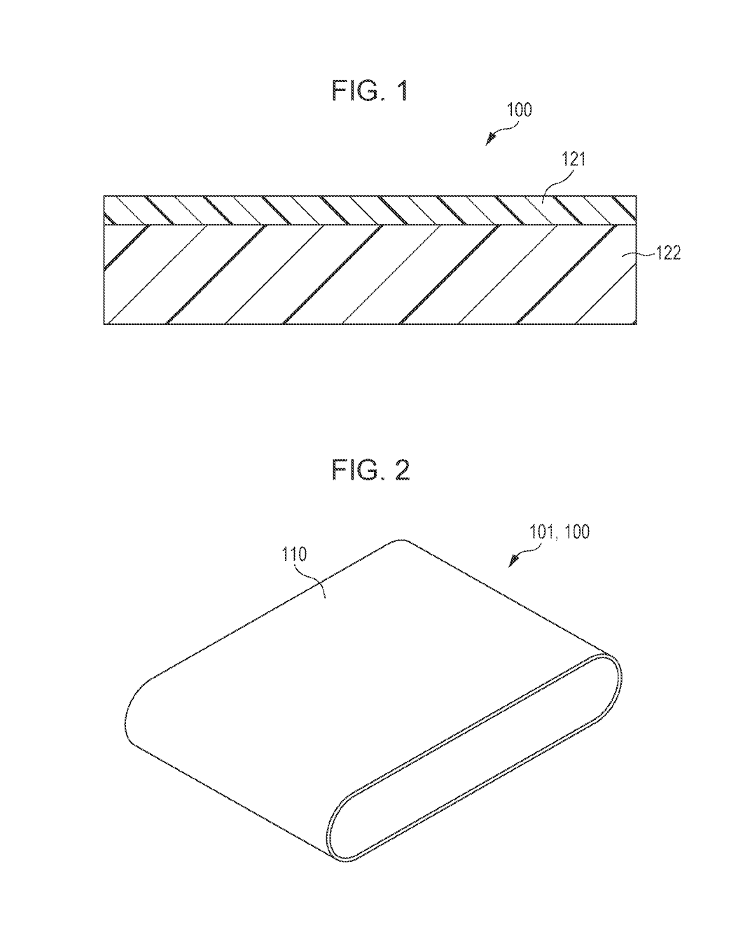

FIG. 1 is a schematic sectional view of a polyimide resin film according to an exemplary embodiment (hereinafter “film”).

Referring to FIG. 1, a film 100 according to this exemplary embodiment is illustrated. The film 100 is a laminate of a substrate layer 122 and an outermost layer 121 disposed on the substrate layer 122.

The outermost layer 121 is a layer containing a polyimide resin, fluoropolymer particles, and a compound represented by general formula (II).

The compound represented by general formula (II) is equivalent to a nonionic fluorinated surfactant.

The above composition of the outermost layer 121 of the film 100 according to this exemplary embodiment may allow the fluoropolymer particles to have a higher dispersibility in the outermost layer 121 than in an outermost layer containing no compound represented by general formula (II).

An example of a method for dispersing fluoropolymer particles in a resin is to add a fluorinated graft polymer to the resin. This method is effective for improving the dispersibility of fluoropolymer particles in urethane resins, for example, although the method will be less effective for polyimide resins, as used in this exemplary embodiment, than for urethane resins.

In contrast, the outermost layer 121 of the film 100 according to this exemplary embodiment, containing a polyimide resin and a compound represented by general formula (II), may allow the fluoropolymer particles to have a higher dispersibility in the outermost layer 121 than in an outermost layer containing a fluorinated graft polymer rather than a compound represented by general formula (II).

While the mechanism by which the compound represented by general formula (II) improves the dispersibility of the fluoropolymer particles is not fully understood, it is believed to be as follows.

Specifically, the compound represented by general formula (II) may be smaller in molecular size and may therefore be more efficiently adsorbed onto the fluoropolymer particles than a fluorinated graft polymer. In addition, the compound represented by general formula (II) may have a higher molecular mobility and may therefore more easily form a stable structure between the resin, the fluoropolymer particles, and the solvent than a fluorinated graft polymer. In particular, if the resin is a polyimide resin, as in this exemplary embodiment, an amine solvent may be used in the manufacture of a polyimide resin film. In this case, a compound represented by general formula (II) and a fluorinated graft polymer may have a particularly large difference in the ability to form the stable structure.

Thus, in this exemplary embodiment, the compound represented by general formula (II) may be efficiently adsorbed onto the fluoropolymer particles, and the adsorbed compound represented by general formula (II) may easily form a stable structure between the resin, the fluoropolymer particles, and the solvent. The fluoropolymer particles may therefore be easily dispersed in the resin and be inhibited from reaggregating by the intervention of the compound represented by general formula (II) and the resin. This may allow the fluoropolymer particles to have high dispersibility in the outermost layer 121.

In addition, because the resin used in this exemplary embodiment is a polyimide resin, the compound represented by general formula (II) may improve the dispersibility of the fluoropolymer particles more effectively than in another resin.

Because the film 100 according to this exemplary embodiment may allow the fluoropolymer particles to be well dispersed in the outermost layer 121, the outermost layer 121 may maintain its ability to retain the fluoropolymer particles, thus inhibiting removal of the fluoropolymer particles and formation of voids. The film 100 according to this exemplary embodiment may therefore easily maintain high surface releasability.

An image-forming apparatus including a tubular or substantially tubular member made of the film 100 according to this exemplary embodiment as an intermediate transfer member may smoothly transfer an image from the intermediate transfer member to a recording medium because of the high surface releasability the intermediate transfer member, thus forming a high-quality image.

Because the intermediate transfer member, which is a tubular or substantially tubular member made of the film 100 according to this exemplary embodiment, contains a polyimide resin, the intermediate transfer member may be less susceptible to a decrease in resistivity (particularly, a decrease in resistivity at high voltage (e.g., 500 V)) due to wear of the outermost layer 121 than an intermediate transfer member having the fluoropolymer particles dispersed in another resin.

The components and properties of the film 100 according to this exemplary embodiment will now be described.

### Outermost Layer

The outermost layer 121 will be described first.

The outermost layer 121 contains a polyimide resin, a compound represented by general formula (II), and fluoropolymer particles. The outermost layer 121 may contain other components depending on the purpose of the film 100.

### Polyimide Resin

The polyimide resin will now be described.

The polyimide resin may be, for example, an imide derivative of a polyamic acid, that is, a polymer of a tetracarboxylic dianhydride and a diamine. For example, the polyimide resin is obtained by polymerizing equimolar amounts of a tetracarboxylic dianhydride and a diamine in a solvent and imidizing the resulting polyamic acid.

An example of a tetracarboxylic dianhydride is represented by general formula (I):

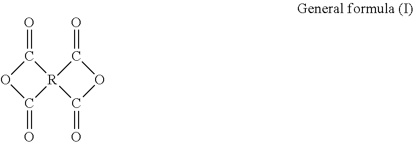

(where R is a tetravalent organic group selected from the group consisting of aromatic groups, aliphatic groups, alicyclic groups, combinations of aromatic and aliphatic groups, and substituted derivatives thereof).

Examples of tetracarboxylic dianhydrides include pyromellitic dianhydride, 3,3′,4,4′-benzophenonetetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)sulfonic dianhydride, perylene-3,4,9,10-tetracarboxylic dianhydride, bis(3,4-dicarboxyphenyl)ether dianhydride, and ethylenetetracarboxylic dianhydride.

Examples of diamines include 4,4′-diaminodiphenyl ether, 4,4′-diaminodiphenylmethane, 3,3′-diaminodiphenylmethane, 3,3′-dichlorobenzidine, 4,4′-diaminodiphenyl sulfide, 3,3′-diaminodiphenylsulfone, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(β-amino-t-butyl)toluene, bis(p-β-amino-t-butylphenyl)ether, bis(p-β-methyl-δ-aminophenyl)benzene, bis-p-(1,1-dimethyl-5-amino-benzyl)benzene, 1-isopropyl-2,4-m-phenylenediamine, m-xylylenediamine, p-xylylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

The solvent used for polymerization of the tetracarboxylic dianhydride and the diamine may be, for example, a polar solvent (organic polar solvent). Examples of polar solvents include N,N-dialkylamides (e.g., low-molecular-weight N,N-dialkylamides such as N,N-dimethylformamide, N,N-dimethylacetoamide, N,N-diethylformamide, N,N-diethylacetoamide, and N,N-dimethylmethoxyacetoamide), dimethyl sulfoxide, hexamethylphosphortriamide, N-methyl-2-pyrrolidone, pyridine, tetramethylenesulfone, and dimethyltetramethylenesulfone. These solvents may be used alone or in combination.

The content of the polyimide resin is, for example, 10% to 80% by mass, preferably 20% to 75% by mass, more preferably 40% to 70% by mass, of the total amount of components of the outermost layer 121.

The outermost layer 121 may contain either a single polyimide resin or a combination of two or more polyimide resins.

The polyimide resin may be used alone or in combination with another resin. Examples of other resins include polyamide resins, polyamideimide resins, polyetheretherester resins, polyarylate resins, polyester resins, and reinforced polyester resins. The content of the other resin is, for example, 30% by mass or less of the total amount of resin.

### Fluoropolymer Particles

The fluoropolymer particles will now be described.

Examples of fluoropolymer particles include particles of ethylene tetrafluoride resins, ethylene trifluoride chloride resins, propylene hexafluoride resins, vinyl fluoride resins, vinylidene fluoride resins, ethylene difluoride dichloride resins, and copolymers thereof.

Particularly preferred are polytetrafluoroethylene (PTFE), tetrafluoroethylene-hexafluoropropylene-perfluoroalkyl vinyl ether copolymer (FEP), and tetrafluoroethylene-perfluoroalkyl vinyl ether copolymer (PFA).

The fluoropolymer particles may be primary particles, composite particles having a composite particle size of 2 μm or less (preferably 1 μm or less, more preferably 0.5 μm or less), or a mixture thereof.

This means that the fluoropolymer particles are contained and dispersed as primary particles, composite particles (aggregates of two or more primary particles), or a mixture thereof and that the composite particle size of the aggregate particles falls within the above range; that is, the fluoropolymer particles are dispersed without substantial aggregation.

The fluoropolymer particles may have a primary particle size (particle size of unaggregated particles) of 0.1 to 0.3 μm.

The primary and composite particle sizes of the fluoropolymer particles are determined by removing a sample from the outermost layer 121 of the film 100, observing the sample under a scanning electron microscope (SEM) at, for example, 5,000× or higher magnification, measuring the maximum sizes of 50 fluoropolymer particles (primary particles or aggregate particles), and averaging the measured maximum sizes. A JSM-6700F scanning electron microscope available from JEOL Ltd. is used to observe a secondary electron image at an acceleration voltage of 5 kV.

The content of the fluoropolymer particles is, for example, 1% to 50% by mass, preferably 2% to 45% by mass, more preferably 3% to 40% by mass, of the total amount of components of the outermost layer 121.

The outermost layer 121 may contain either a single type of fluoropolymer particles or a combination of two or more types of fluoropolymer particles.

### Compound Represented by General Formula (II)

The compound represented by general formula (II) is as follows:

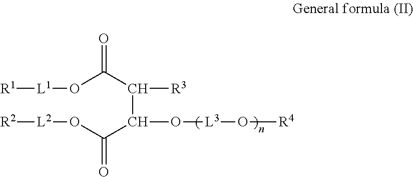

where R¹ and R² are each independently a fully fluorinated linear or branched alkyl or a partially fluorinated linear or branched alkyl; R³ is hydrogen, methyl, or ethyl; R⁴ is hydrogen or a linear or branched alkyl; L¹ and L² are each independently a single bond or a linear or branched alkylene; L³ is a linear or branched alkylene; and n is an integer of 5 to 500 or about 5 to about 500.

R¹ and R² in general formula (II) will be described first.

In general formula (II), R¹ and R², as defined above, are each independently a linear or branched fluorinated alkyl. The fluorinated alkyl may be either a fully fluorinated alkyl or a partially fluorinated alkyl.

The fluorinated alkyl represented by R¹ and R² in general formula (II) has, for example, one to ten carbon atoms, preferably two to eight carbon atoms. The fluorinated alkyl represented by R¹ and R² is preferably linear.

The fluorinated alkyl represented by R¹ and R² may have any number of fluorine atoms. For example, the fluorinated alkyl represented by R¹ and R² has one or more fluorine atoms, preferably two or more fluorine atoms, depending on the number of carbon atoms. More preferably, the fluorinated alkyl represented by R¹ and R² is a perfluoroalkyl.

Examples of fluorinated alkyls represented by R¹ and R² include perfluorobutyl, perfluoropentyl, perfluorohexyl, perfluoroheptyl, perfluorooctyl, and derivatives thereof partially substituted with hydrogen.

R¹ and R² in general formula (II) may be the same or different.

Particularly preferred for R¹ and R² are linear fluorinated alkyls having one to ten carbon atoms, more preferably linear perfluoroalkyls having two to nine carbon atoms.

Next, R³ and R⁴ in general formula (II) will be described.

In general formula (II), R³, as defined above, is hydrogen, methyl, or ethyl. In general formula (II), R⁴, as defined above, is hydrogen, a linear or branched alkyl, or an alkyl alcohol.

Particularly preferred for R³ in general formula (II) is hydrogen.

The alkyl represented by R⁴ in general formula (II) has, for example, one to ten carbon atoms, preferably one to eight carbon atoms. The alkyl represented by R⁴ in general formula (II) is preferably linear.

Examples of alkyls represented by R⁴ include methyl, ethyl, propyl, and butyl.

The alkyl alcohol represented by R⁴ in general formula (II) has, for example, one to ten carbon atoms, preferably one to eight carbon atoms.

Examples of alkyl alcohols represented by R⁴ include methyl alcohol, ethyl alcohol, and propyl alcohol.

Particularly preferred for R⁴ in general formula (II) are hydrogen, alkyls having one to ten carbon atoms, and alkyl alcohols, more preferably alkyls having one to eight carbon atoms.

Next, L¹ and L² in general formula (II) will be described.

In general formula (II), L¹ and L², as defined above, are each independently a single bond or a linear or branched alkylene.

The alkylene represented by L¹ and L² in general formula (II) has, for example, one to six carbon atoms, preferably one to three carbon atoms. The alkylene represented by L¹ and L² is preferably linear.

Examples of alkylenes represented by L¹ and L² include ethylene, propylene, 1-methylethylene, and 2-methylethylene.

L¹ and L² in general formula (II) may be the same or different.

Next, L³ in general formula (II) will be described.

In general formula (II), L³, as defined above, is a linear or branched alkylene.

The alkylene represented by L³ in general formula (II) has, for example, one to ten carbon atoms, preferably two to eight carbon atoms.

Examples of alkylenes represented by L³ include —CH₂CH₂—, —CH₂CH(CH₃)—, —CH(CH₃)CH₂—, —CH₂CH₂CH₃—, and —CH₂CH₂CH₃CH₃—.

Particularly preferred for L³ in general formula (II) are —CH₂CH₂—, —CH₂CH(CH₃)—, and —CH₂CH₂CH₃CH₃—, more preferably —CH₂CH₂— and —CH₂CH(CH₃)—.

Next, n in general formula (II) will be described.

In general formula (II), n, as defined above, is an integer of 5 to 500 or about 5 to about 500, preferably 10 to 300 or about 10 to about 300.

Examples of compounds represented by general formula (II) include, but not limited to, the following compounds (exemplary compounds (II-1) to (II-10)):

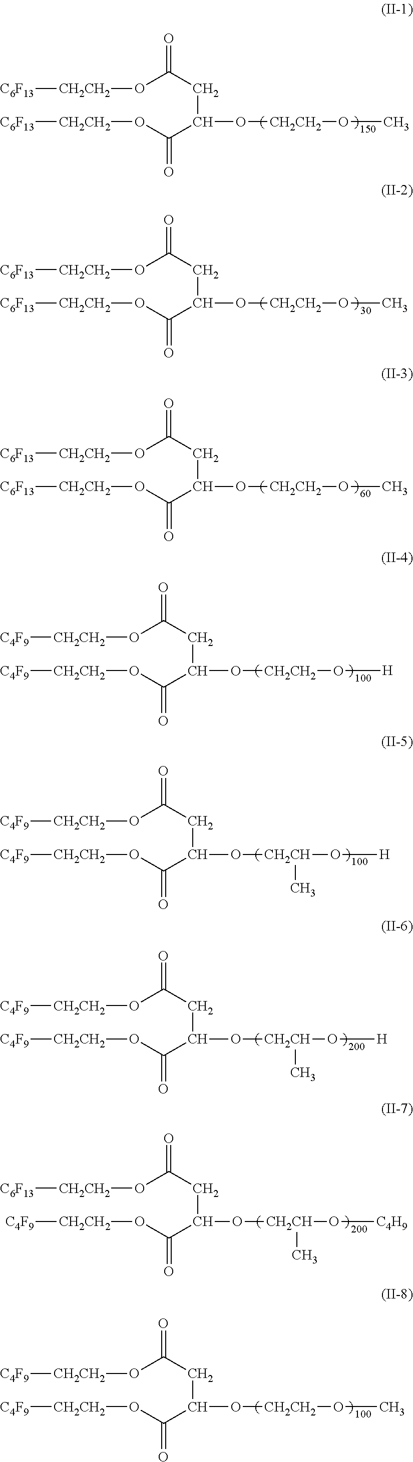

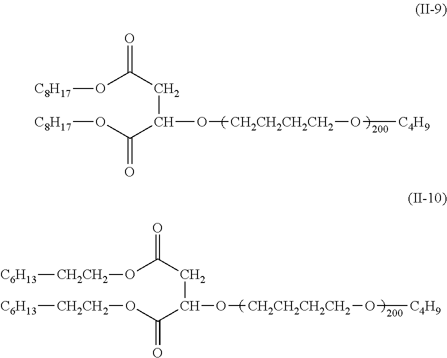

The compound represented by general formula (II) has a number average molecular weight of, for example, 1,000 to 30,000 or about 1,000 to about 30,000, preferably 300 to 4,000 or about 300 to about 4,000, more preferably 500 to 3,000 or about 500 to about 3,000.

The number average molecular weight is measured by gel permeation chromatography (GPC) using HLC-8120GPC available from Tosoh Corporation, where the column temperature is 40° C., the pump flow rate is 0.4 mL/min, and the detector is RI (built into the GPC system). The data is processed using a calibration curve (calibration at molecular weights of 1,000 and more) for a standard polyethylene glycol (PEG) of known molecular weight to determine the PEG equivalent molecular weight, thus obtaining the molecular weight. The measurement conditions are as follows:

Column: SuperAWM-H+SuperAWM-H+SuperAW3000

Mobile phase: 10 mM LiBr+N-methylpyrrolidone

Amount injected: 20 μL

Sample concentration: 0.1% (w/w)

The content of the compound represented by general formula (II) is, for example, 0.1 to 10 parts by mass, preferably 0.2 to 9 parts by mass, more preferably 0.5 to 8 parts by mass, based on 100 parts by mass of the fluoropolymer particles.

In addition to the compound represented by general formula (II), the outermost layer 121 may optionally contain another surfactant.

### Other Components

The outermost layer 121, as described above, may contain other components depending on the purpose of the film 100. For example, if the film 100 is used as a transfer member such as an intermediate transfer member (e.g., an intermediate transfer belt) or a transport transfer member (e.g., a transport transfer belt), the outermost layer 121 may contain a conductive material to make the film 100 semiconductive (e.g., a volume resistivity of 10⁷ to 10¹³ Ω·cm; the same applies hereinafter).

Examples of conductive materials include conductive (e.g., a volume resistivity of less than 10⁷ Ω·cm; the same applies hereinafter) or semiconductive powders (e.g., powders composed of particles having a primary particle size of less than 10 μm, preferably 1 μl or less).

Examples of conductive materials include, but not limited to, carbon black (e.g., Ketjenblack, acetylene black, and surface-oxidized carbon black), metals (e.g., aluminum and nickel), metal oxides (e.g., yttrium oxide and tin oxide), ionically conductive materials (e.g., potassium titanate and LiCl), and conductive polymers (e.g., polyaniline, polypyrrole, polysulfone, and polyacetylene).

The conductive material is selected depending on the purpose thereof. In view of the stability of electrical resistance over time and electric field dependence, which is associated with inhibition of electric field concentration due to a transfer voltage, an oxidized carbon black (e.g., a carbon black having the surface thereof modified with, for example, carboxyl, quinone, lactone, or hydroxyl) having a pH of 5 or less (preferably 4.5 or less, more preferably 4.0 or less) may be used. In view of electrical durability, a conductive polymer (e.g., polyaniline) may be used.

The content of the conductive material is, for example, 1% to 50% by mass, preferably 2% to 40% by mass, more preferably 4% to 30% by mass, of the total amount of components of the outermost layer 121.

The outermost layer 121 may contain either a single conductive material or a combination of two or more conductive materials.

### Substrate Layer

The substrate layer 122 will now be described.

The substrate layer 122 contains, for example, a resin material.

The substrate layer 122 may contain other components depending on the purpose of the film 100. For example, if the film 100 is used as a transfer member, as noted above, the substrate layer 122 may contain a conductive material to make the film 100 semiconductive.

### Resin Material

The resin material will be described.

Examples of resin materials include polyimide resins, polyamide resins, polyamideimide resins, polyetheretherester resins, polyarylate resins, polyester resins, and reinforced polyester resins.

For example, if the film 100 is used as a transfer belt such as an intermediate transfer belt or a transport transfer belt, it may satisfy the mechanical properties required of belts if the resin material has a Young's modulus of 3,500 MPa or more, more preferably 4,000 MPa or more, depending on the belt thickness.

Young's modulus is determined by performing a tensile test in accordance with JIS K 7127 (1999) (Japanese Industrial Standards), drawing a tangent to the initial strain region of the resulting stress-strain curve, and calculating the gradient thereof. The measurement is performed using a strip specimen (6 mm wide and 130 mm long) of JIS No. 1 dumbbell type at a test speed of 500 mm/min, with the thickness set at the belt thickness.

Particularly preferred are polyimide resins, which may be more resistant to deformation during the rotation of the belt than other resins because of their high Young's modulus.

In particular, because the outermost layer 121 contains a polyimide resin in this exemplary embodiment, as noted above, a substrate layer 122 containing a polyimide resin may allow the outermost layer 121 to have high adhesion to the substrate layer 122, which is an underlying layer in contact with the outermost layer 121, thus inhibiting the outermost layer 121 from peeling.

The polyimide resin may be, for example, similar to the polyimide resin used for the outermost layer 121.

### Conductive Material

The conductive material will now be described.

The conductive material may be, for example, similar to the conductive material used for the outermost layer 121.

### Shape and Properties of Polyimide Resin Film

The shape and properties of the film 100 according to this exemplary embodiment will now be described.

The shape of the film 100 may be any shape selected depending on the purpose, such as a sheet shape or endless tubular shape. For example, if the film 100 is used as a sliding member for fixing, the film 100 may be a polyimide resin sheet. If the film 100 is used as a transfer belt, a fixing belt, or a sheet transport belt, the film 100 may be an endless tubular member.

For example, if the film 100 is a polyimide resin sheet for use as a sliding member for fixing, the outermost layer 121 has a thickness of, for example, 5 to 100 μm, preferably 10 to 80 μm, and the substrate layer 122 has a thickness of, for example, 30 to 120 μm, preferably 50 to 100 μm.

An endless tubular member made of the film 100 will now be described.

FIG. 2 is a schematic perspective view of a tubular or substantially tubular member made of the film 100 according to this exemplary embodiment (hereinafter “endless belt”).

Referring to FIG. 2, an endless belt 101 made of the film 100 according to this exemplary embodiment is illustrated. The outermost layer 121 forms the outer surface 110 of the endless belt 101.

The thickness of the outermost layer 121 of the endless belt 101 is, for example, 5 to 100 μm, preferably 5 to 90 μm, more preferably 5 to 80 μm. The thickness of the substrate layer 122 of the endless belt 101 is, for example, 30 to 150 μm, preferably 40 to 120 μm, more preferably 50 to 100 μm.

If the endless belt 101 is used as an intermediate transfer member (intermediate transfer belt), the surface resistivity of the outer surface thereof is preferably 9 to 13 log Ω/sq, more preferably 10 to 12 log Ω/sq, on a common logarithmic scale. A surface resistivity of more than 13 log Ω/sq on a common logarithmic scale 30 milliseconds after energization might cause the intermediate transfer member to electrostatically attract a recording medium and not to release it after second transfer. A surface resistivity of less than 9 log Ω/sq on a common logarithmic scale 30 milliseconds after energization might result in an insufficient ability to retain a toner image transferred to the intermediate transfer member, thus causing image granularity and irregularities. The common logarithm of the surface resistivity is controlled depending on the type and amount of conductive material added, described later.

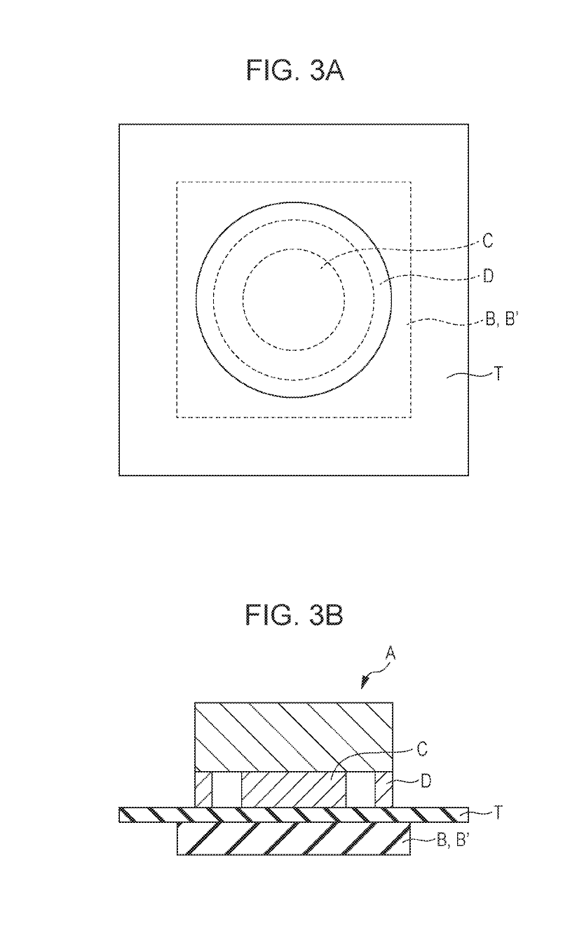

A procedure for measuring the surface resistivity is as follows. The surface resistivity is measured using a circular probe (e.g., UR Probe for HIRESTA IP available from Mitsubishi Petrochemical Co., Ltd.) in accordance with JIS K 6911. The procedure for measuring the surface resistivity will be described with reference to FIGS. 3A and 3B. FIGS. 3A and 3B are a schematic plan view and a schematic sectional view, respectively, of an example of a circular probe. The circular probe illustrated in FIGS. 3A and 3B includes a first voltage-applying electrode A and an insulating plate B. The first voltage-applying electrode A has a cylindrical electrode C and a ring electrode D having an inner diameter larger than the outer diameter of the cylindrical electrode C and surrounding the cylindrical electrode C at a predetermined spacing. A belt T is supported between the electrodes C and D on the first voltage-applying electrode A and the insulating plate B to measure the current I (A) that flows between the electrodes C and D on the first voltage-applying electrode A as a voltage V (V) is applied thereacross. The surface resistivity ρs (Ω/sq) of a transfer surface of the belt T is calculated by the following equation:

ρs=π×(D+d)/(D−d)×(V/I)

where d (mm) is the outer diameter of the cylindrical electrode C, and D (mm) is the inner diameter of the ring electrode D.

The surface resistivity is calculated from the current measured using the circular probe (UR Probe of HIRESTA IP available from Mitsubishi Petrochemical Co., Ltd., outer diameter of cylindrical electrode C: 16 mm, inner diameter of ring electrode D: 30 mm, outer diameter of ring electrode D: 40 mm) at 22° C. and 55% RH after a voltage of 500 V is applied for ten seconds.

If the endless belt 101 according to this exemplary embodiment is used as an intermediate transfer member (intermediate transfer belt), the volume resistivity of the entire endless belt 101 may be 8 to 13 log Ωcm on a common logarithmic scale. A volume resistivity of less than 8 log Ωcm on a common logarithmic scale might result in an insufficient ability to electrostatically maintain charge on an unfixed toner image transferred from the image carrier to the intermediate transfer member. This might cause the toner to be scattered around the image by electrostatic repulsion between toner particles and a fringe field at the edges of the image, thus forming an image with considerable noise. A volume resistivity of more than 13 log Ωcm on a common logarithmic scale might cause the surface of the intermediate transfer member to be charged by a transfer field during first transfer because of the high ability to maintain charge, thus requiring an erasing mechanism. The common logarithm of the volume resistivity is controlled depending on the type and amount of conductive material added, described later.

The volume resistivity is measured using a circular probe (e.g., UR Probe of HIRESTA IP available from Mitsubishi Petrochemical Co., Ltd.) in accordance with JIS K 6911. The procedure for measuring the surface resistivity will be described with reference to FIGS. 3A and 3B. The instrument used for volume resistivity measurement is the same as the instrument used for surface resistivity measurement except that the circular probe illustrated in FIGS. 3A and 3B has a second voltage-applying electrode B′ rather than the insulating plate B used for surface resistivity measurement. The belt T is supported between the electrodes C and D of the first voltage-applying electrode A and the second voltage-applying electrode B′ to measure the current I (A) that flows between the cylindrical electrode C on the first voltage-applying electrode A and the second voltage-applying electrode B′ as a voltage V (V) is applied thereacross. The volume resistivity ρs (Ω·cm) of the belt T is calculated by the following equation:

ρv=19.6×(V/I)×t

where t is the thickness of the belt T.

The volume resistivity is calculated from the current measured using the circular probe (UR Probe of HIRESTA IP available from Mitsubishi Petrochemical Co., Ltd., outer diameter of cylindrical electrode C: 16 mm, inner diameter of ring electrode D: 30 mm, outer diameter of ring electrode D: 40 mm) at 22° C. and 55% RH after a voltage of 500 V is applied for ten seconds.

The coefficient 19.6 in the above equation is an electrode coefficient for conversion to resistivity and is calculated as πd²/4t from the outer diameter d (mm) of a cylindrical electrode and the thickness t (cm) of a specimen. The thickness of the belt T is measured using a CTR-1500E eddy-current type thickness meter available from Sanko Electronic Laboratory Co., Ltd.

### Method for Manufacturing Polyimide Resin Film

As a non-limiting example of the method for manufacturing the film 100 according to this exemplary embodiment, a method for manufacturing the endless belt 101 made of the film 100 will now be described. To manufacture a polyimide resin sheet made of the film 100, for example, a core, described later, may be selected depending on the shape of the sheet.

The method for manufacturing the endless belt 101 described below uses a polyimide resin as the resin material for the substrate layer 122 and carbon black as the conductive material for the substrate layer 122 and the outermost layer 121, although the materials are not limited thereto.

The core is prepared first. The core is, for example, a cylindrical die. The core is made of, for example, a metal such as aluminum, stainless steel, or nickel. The core requires a length larger than or equal to that of the intended endless belt. The core may be 10% to 40% longer than the intended endless belt.

A polyamic acid solution having carbon black dispersed therein is then prepared as a coating solution for forming the substrate layer 122.

For example, a polyamic acid solution having carbon black dispersed therein may be prepared by dissolving a tetracarboxylic dianhydride and a diamine in an organic polar solvent, dispersing carbon black therein, and facilitating polymerization. Alternatively, the polyamic acid solution may be prepared by dissolving a tetracarboxylic dianhydride and a diamine in an organic polar solvent, facilitating polymerization, adding carbon black, and dispersing the carbon black using, for example, a high-pressure disperser.

In this process, the monomer concentrations of the polyamic acid solution (the concentrations of the tetracarboxylic dianhydride and the diamine in the solvent) may be 5% to 30% by mass, depending on various conditions. The polymerization temperature is preferably set to 80° C. or lower, more preferably 5° C. to 50° C. The polymerization time may be five to ten hours.

The coating solution for forming the substrate layer 122 is then applied to the cylindrical die as the core to form a coating of the coating solution for forming the substrate layer 122.

The coating solution may be applied to the cylindrical die by a method such as, but not limited to, dipping the outer surface of the cylindrical die in the coating solution, applying the coating solution to the inner surface of the cylindrical die, or applying the coating solution to the outer or inner surface of the cylindrical die while rotating the die with the axis thereof being horizontal (i.e., spiral coating or die coating).

The coating of the coating solution for forming the substrate layer 122 is then dried to form a film that is to form the substrate layer 122 (dry film before imidation). For example, the coating may be dried at 80° C. to 200° C. for 10 to 60 minutes, which may be shortened at higher temperatures. It is also effective to blow hot air during heating. The heating temperature may be raised stepwise or at a constant rate. The core may be rotated at 5 to 60 rpm with the axis thereof being horizontal. After drying, the core may be placed vertically.

A mixed solution containing a polyamic acid, fluoropolymer particles, a compound represented by general formula (II), and carbon black is then prepared as a coating solution for forming the outermost layer 121.

Specifically, a polyamic acid solution having carbon black dispersed therein is prepared by dissolving a tetracarboxylic dianhydride and a diamine in an organic polar solvent, dispersing carbon black therein, and facilitating polymerization.

In addition, a fluoropolymer particle dispersion is prepared by adding fluoropolymer particles and a compound represented by general formula (II) to an organic polar solvent.

The polyamic acid solution having carbon black dispersed therein and the fluoropolymer particle dispersion are mixed together to obtain a mixed solution as the coating solution for forming the outermost layer 121.

The organic polar solvent used for the fluoropolymer particle dispersion is, for example, a solvent similar to the solvent used for the polymerization reaction noted above. The organic polar solvent may be the same solvent used for the polyamic acid solution having carbon black dispersed therein.

The fluoropolymer particle dispersion may be allowed to stand before the mixing of the polyamic acid solution having carbon black dispersed therein and the fluoropolymer particle dispersion in order to allow the compound represented by general formula (II) to be efficiently adsorbed in advance on the surfaces of the fluoropolymer particles. The fluoropolymer particle dispersion may be allowed to stand, for example, for 0.1 to 100 hours, preferably 1 to 50 hours. The temperature of the fluoropolymer particle dispersion during this step is, for example, 10° C. to 40° C., preferably 15° C. to 30° C.

The polyamic acid solution having carbon black dispersed therein and the fluoropolymer particle dispersion may be mixed together under pressure (shear) using, for example, a high-pressure disperser (i.e., by high-pressure dispersion treatment). The pressure in the mixing step is, for example, 10 to 300 MPa (i.e., 10 to 300 N/mm²), preferably 30 to 250 MPa (i.e., 30 to 250 N/mm²). The time for the mixing step is, for example, 0.5 to 20 hours, preferably 1 to 15 hours.

The monomer concentrations of the mixed solution (the concentrations of the tetracarboxylic dianhydride and the diamine) and the polymerization temperature and time (the temperature and time for polymerization of the tetracarboxylic dianhydride and the diamine) may be similar to those for the polyamic acid solution used as the coating solution for forming the substrate layer 122.

The coating solution for forming the outermost layer 121 is then applied to the film that is to form the substrate layer 122 to form a coating of the coating solution for forming the outermost layer 121.

The coating solution may be applied to the cylindrical die by a method such as, but not limited to, the method used for applying the coating solution for forming the substrate layer 122.

The coating of the coating solution for forming the outermost layer 121 is then dried to form a film that is to form the outermost layer 121 (dry film before imidation). The drying conditions may be similar to those for the coating of the coating solution for forming the substrate layer 122.

The films that are to form the substrate layer 122 and the outermost layer 121 are then subjected to imidation treatment (baking) and are removed from the core. Thus, the endless belt 101 is obtained as the laminate of the substrate layer 122 and the outermost layer 121.

In the imidation treatment (baking), the films are heated, for example, at 250° C. to 450° C. (preferably 300° C. to 350° C.) for 20 to 60 minutes to facilitate imidation reaction, thus forming a polyimide resin film. The heating temperature may be raised stepwise or gradually at a constant rate before reaching the final temperature.

The films that are to form the substrate layer 122 and the outermost layer 121 may be simultaneously subjected to imidation treatment (baking) for higher adhesion between the substrate layer 122 and the outermost layer 121. Alternatively, the film that is to form the substrate layer 122 may be subjected to imidation treatment (baking) to form the substrate layer 122 before the coating solution for forming the outermost layer 121 is applied and subjected to imidation treatment (baking) to form the outermost layer 121.

While the endless belt 101 according to the illustrated exemplary embodiment is a laminate of two layers, namely, the substrate layer 122 and the outermost layer 121, it may take any form including as the outermost layer 121 a layer containing a polyimide resin, fluoropolymer particles, and a compound represented by general formula (II). For example, the endless belt 101 may be a laminate of more than two layers (for example, a laminate of the outermost layer 121 and the substrate layer 122 with an intermediate layer therebetween, or a laminate including a substrate layer 122 that itself is a laminate of two or more layers).

Alternatively, the endless belt 101 according to this exemplary embodiment may be a single layer containing a polyimide resin, fluoropolymer particles, and a compound represented by general formula (II).

### Tubular Member Unit

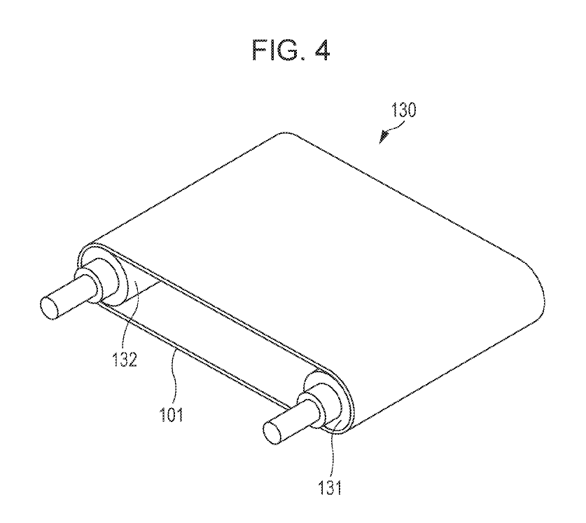

FIG. 4 is a schematic perspective view of a tubular member unit according to this exemplary embodiment.

Referring to FIG. 4, a tubular member unit 130 (hereinafter “endless belt unit”) according to this exemplary embodiment is illustrated. The tubular member unit 130 includes the endless belt 101 according to this exemplary embodiment. For example, the endless belt 101 is entrained under tension about a drive roller 131 and a driven roller 132 disposed opposite each other.

If the endless belt 101 is used as an intermediate transfer member, the endless belt unit 130 according to this exemplary embodiment is provided, as support rollers, with a first transfer roller for transferring a toner image from the surface of a photoreceptor (image carrier) to the endless belt 101 and a second transfer roller for transferring the toner image from the endless belt 101 to a recording medium.

The endless belt 101 may be provided with any number of support rollers, depending on the manner in which the endless belt 101 is used. The thus-configured endless belt unit 130 is incorporated and used in a system in which the endless belt 101 is rotated as the drive roller 131 and the driven roller 132 rotate.

### Image-Forming Apparatus

An image-forming apparatus according to this exemplary embodiment includes an image carrier, a charging unit that charges a surface of the image carrier, a latent-image forming unit that forms a latent image on the surface of the image carrier, a developing unit that develops the latent image with a toner to form a toner image, a transfer unit that transfers the toner image to a recording medium, and a fixing unit that fixes the toner image to the recording medium. The transfer unit includes the endless belt 101 according to this exemplary embodiment.

Specifically, the transfer unit of the image-forming apparatus according to this exemplary embodiment includes, for example, an intermediate transfer member, a first transfer unit that transfers the toner image from the image carrier to the intermediate transfer member, and a second transfer unit that transfers the toner image from the intermediate transfer member to the recording medium. The intermediate transfer member is the endless belt 101 according to this exemplary embodiment.

Alternatively, the transfer unit of the image-forming apparatus according to this exemplary embodiment includes, for example, a transport transfer member (transport transfer belt) that transports the recording medium and a transfer mechanism that transfers the toner image from the image carrier to the recording medium transported by the transport transfer member. The transport transfer member is the endless belt 101 according to this exemplary embodiment.

The image-forming apparatus according to this exemplary embodiment is, for example, a monochrome image-forming apparatus including a developing device containing a single toner, a color image-forming apparatus that sequentially transfers toner images from image carriers to an intermediate transfer member, or a tandem color image-forming apparatus in which image carriers provided with developing devices for different colors are arranged in tandem on an intermediate transfer member.

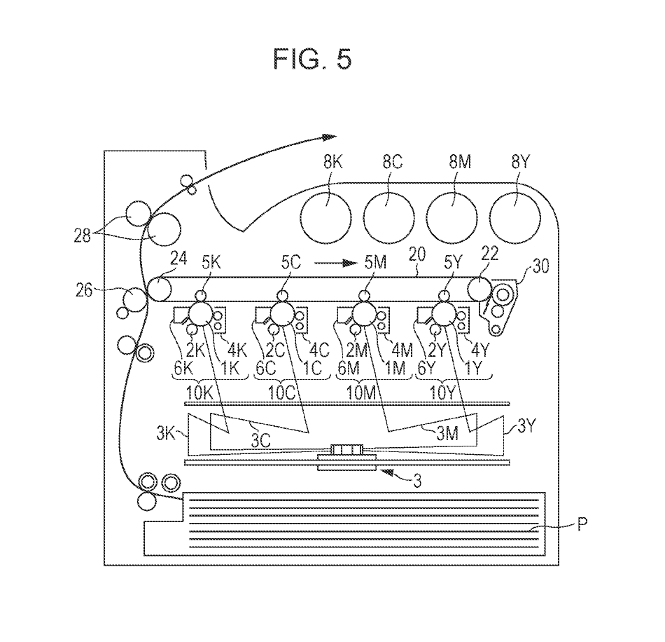

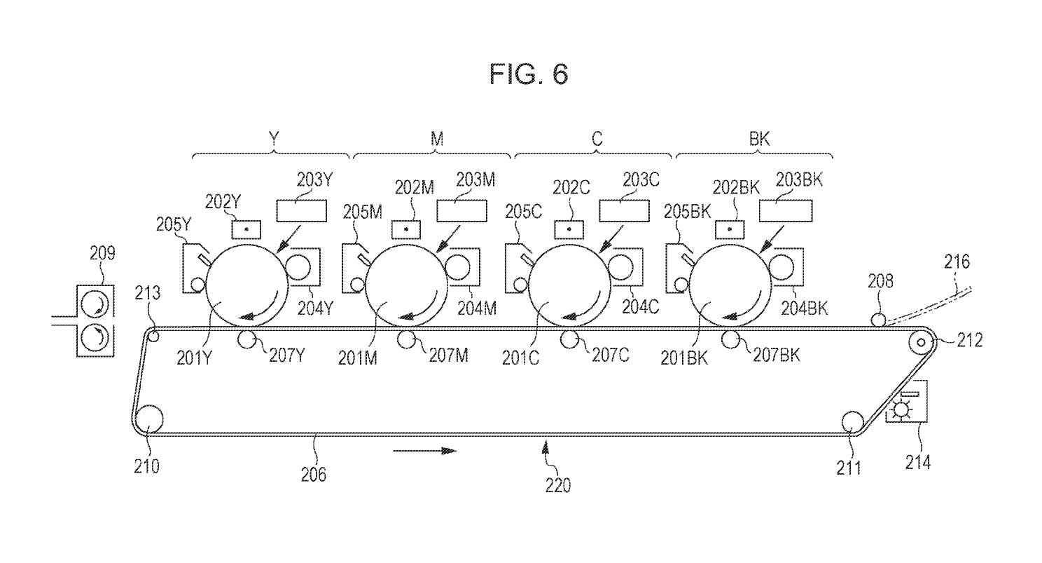

The image-forming apparatus according to this exemplary embodiment will now be described with reference to the drawings. FIG. 5 is a schematic view of an image-forming apparatus according to an exemplary embodiment. FIG. 6 is a schematic view of an image-forming apparatus according to another exemplary embodiment. The image-forming apparatus illustrated in FIG. 5 includes an intermediate transfer member (intermediate transfer belt). The image-forming apparatus illustrated in FIG. 6 includes a transport transfer member (transport transfer member) for transporting a recording medium.

The image-forming apparatus illustrated in FIG. 5 includes first to fourth electrophotographic image-forming units 10Y, 10M, 10C, and 10K that produce yellow (Y), magenta (M), cyan (C), and black (K) images, respectively, based on color separation image data. The image-forming units (hereinafter “units”) 10Y, 10M, 10C, and 10K are arranged side by side at a particular spacing in the horizontal direction. The units 10Y, 10M, 10C, and 10K may be process cartridges attachable to and detachable from the image-forming apparatus.

An intermediate transfer belt 20 is provided as an intermediate transfer member, extending above the units 10Y, 10M, 10C, and 10K in the figure. The intermediate transfer belt 20 is entrained about a drive roller 22 and a support roller 24 spaced apart from the drive roller 22 in the direction from the left to the right of the figure and disposed in contact with the inner surface of the intermediate transfer belt 20. The intermediate transfer belt 20 travels in the direction from the first unit 10Y to the fourth unit 10K. The intermediate transfer belt 20 constitutes the transfer unit of the image-forming apparatus.

A spring (not shown), for example, biases the support roller 24 in the direction away from the drive roller 22 to apply a particular tension to the intermediate transfer belt 20 entrained between the two rollers 22 and 24. An intermediate-transfer-member cleaning device 30 is disposed opposite the drive roller 22 on the image carrier side of the intermediate transfer belt 20.

The units 10Y, 10M, 10C, and 10K include developing devices (developing units) 4Y, 4M, 4C, and 4K, respectively, to which yellow, magenta, cyan, and black toners are supplied from toner cartridges 8Y, 8M, 8C, and 8K, respectively.

The first to fourth units 10Y, 10M, 10C, and 10K have the same structure. The first unit 10Y, which is located upstream in the travel direction of the intermediate transfer belt 20 and which forms a yellow image, will now be described as a representative example. The elements of the second to fourth units 4M, 4C, and 4K corresponding to those of the first unit 10Y are designated by like numerals followed by “M” (magenta), “C” (cyan), or “K” (black), rather than “Y” (yellow), and are not further described herein.

The first unit 10Y includes a photoreceptor 1Y that functions as an image carrier. The photoreceptor 1Y is surrounded in sequence by a charging roller 2Y that charges the surface of the photoreceptor 1Y to a particular potential, an exposure device 3 that exposes the charged surface to a laser beam 3Y based on a color separation image signal to form an electrostatic image, a developing device (developing unit) 4Y that supplies a charged toner to the electrostatic image to develop the electrostatic image, a first transfer roller (first transfer unit) 5Y that transfers the developed image to the intermediate transfer belt 20, and a photoreceptor-cleaning device (cleaning unit) 6Y that removes residual toner from the surface of the photoreceptor 1Y with a cleaning blade after the first transfer.

The first transfer roller 5Y is disposed opposite the photoreceptor 1Y inside the intermediate transfer belt 20. Bias power supplies (not shown) that apply a first transfer bias are connected to the first transfer rollers 5Y, 5M, 5C, and 5K. A controller (not shown) controls the bias power supplies to change the transfer bias applied to the first transfer rollers 5Y, 5M, 5C, and 5K.

The image-forming operation of the first unit 10Y will now be described. Before the operation, the charging roller 2Y charges the surface of the photoreceptor 1Y to a potential of about −600 to about −800 V.

The photoreceptor 1Y includes a conductive substrate (having a volume resistivity at 20° C. of 1×10⁶ Ωcm or less) and a photosensitive layer disposed on the substrate. The photosensitive layer, which normally has high resistivity (comparable to the resistivity of common resins), has the property of changing its resistivity in a region irradiated with the laser beam 3Y. The exposure device 3 directs the laser beam 3Y onto the surface of the charged photoreceptor 1Y based on yellow image data received from the controller (not shown). The laser beam 3Y irradiates the photosensitive layer to form an electrostatic image with a yellow print pattern on the surface of the photoreceptor 1Y.

The electrostatic image is an image formed on the charged surface of the photoreceptor 1Y, that is, a negative latent image formed after the charge on the surface of the photoreceptor 1Y dissipates in the region irradiated with the laser beam 3Y, where the resistivity drops accordingly, while remaining in the region not irradiated with the laser beam 3Y.

As the photoreceptor 1Y rotates, the electrostatic image formed on the photoreceptor 1Y is brought to a particular development position where the electrostatic image is visualized (developed) by the developing device 4Y.

The developing device 4Y contains, for example, a yellow toner. The yellow toner is charged by friction as it is stirred inside the developing device 4Y, thus having a charge of the same polarity as the photoreceptor 1Y (negative polarity). The yellow toner is then carried by a developer roller (developer carrier). As the surface of the photoreceptor 1Y passes through the developing device 4Y, the yellow toner is electrostatically attracted by the neutral latent image pattern on the surface of the photoreceptor 1Y, thus developing the latent image. The photoreceptor 1Y carrying the yellow toner image rotates at a particular speed to transport the toner image developed on the photoreceptor 1Y to a particular first transfer position.

When the yellow toner image on the photoreceptor 1Y is transported to the first transfer position, a particular first transfer bias is applied to the first transfer roller 5Y. The toner image then experiences electrostatic force acting from the photoreceptor 1Y toward the first transfer roller 5Y so that the toner image is transferred from the photoreceptor 1Y to the intermediate transfer belt 20. The first transfer bias has the opposite polarity (positive) to the toner (negative) and is controlled to, for example, about +10 μA in the first unit 10Y by the controller (not shown).

The cleaning device 6Y removes and collects residual toner from the photoreceptor 1Y.

The controller similarly controls the first transfer biases applied to the first transfer rollers 5M, 5C, and 5K of the second to fourth units 10M, 10C, and 10K.

Thus, the intermediate transfer belt 20 having the yellow toner image transferred thereto by the first unit 10Y is sequentially transported through the second to fourth units 10M, 10C, and 10K, and toner images of the respective colors are superimposed on top of each other.

The intermediate transfer belt 20 having the toner images of the four colors superimposed thereon through the first to fourth units 10Y, 10M, 10C, and 10K reaches a second transfer section. The second transfer section includes the intermediate transfer belt 20, the support roller 24 in contact with the inner surface of the intermediate transfer belt 20, and a second transfer roller (second transfer unit) 26 disposed on the image carrier side of the intermediate transfer belt 20. A recording medium P is fed into a nip between the second transfer roller 26 and the intermediate transfer belt 20 at a particular timing by a feed mechanism. A particular second transfer bias is applied to the support roller 24. The second transfer bias has the same polarity (negative) as the toner. The toner image experiences electrostatic force acting from the intermediate transfer belt 20 toward the recording medium P so that the toner image is transferred from the intermediate transfer belt 20 to the recording medium P. The second transfer bias is determined depending on the resistance detected by a resistance detector (not shown) that detects the resistance of the second transfer section and is voltage-controlled.

The recording medium P is then transported to a fixing device (fixing unit) 28. The fixing device 28 heats and fuses the superimposed toner images to fix the toner images to the recording medium P. The recording medium P having the color image fixed thereto is transported to an eject section. Thus, the color-image forming operation is complete.

While the illustrated image-forming apparatus is configured to transfer the toner images from the intermediate transfer belt 20 to the recording medium P, it may be configured in any other manner, for example, to directly transfer the toner images from the photoreceptors 1Y, 1M, 1C, and 1K to the recording medium P.

The image-forming apparatus illustrated in FIG. 6 includes image-forming units Y, M, C, and BK. The image-forming units Y, M, C, and BK include photoreceptor drums 201Y, 201M, 201C, and 201BK, respectively, that rotate clockwise, as indicated by the arrows, at a particular peripheral velocity (process speed). The photoreceptor drums 201Y, 201M, 201C, and 201BK are respectively surrounded by charging rollers 202Y, 202M, 202C, and 202BK; exposure devices 203Y, 203M, 203C, and 203BK; yellow, magenta, cyan, and black developing devices 204Y, 204M, 204C, and 204BK; and photoreceptor-drum cleaning members 205Y, 205M, 205C, and 205BK.

The four image-forming units Y, M, C, and BK are arranged in parallel on a transport transfer belt 206 in the following order: the image-forming units BK, C, M, and Y. The image-forming units Y, M, C, and BK, however, may be arranged in any order, such as the image-forming units BK, Y, C, and M, depending on the image-forming process.

The transport transfer belt 206 is supported by belt support rollers 210, 211, 212, and 213 disposed inside the transport transfer belt 206 and constitutes the transfer unit of the image-forming apparatus. The transport transfer belt 206 rotates counterclockwise, as indicated by the arrow, at the same peripheral velocity as the photoreceptor drums 201Y, 201M, 201C, and 201BK. The portion of the transport transfer belt 206 between the belt support rollers 212 and 213 is disposed in contact with the photoreceptor drums 201Y, 201M, 201C, and 201BK. The transport transfer belt 206 is provided with a belt-cleaning member 214.

Transfer rollers 207Y, 207M, 207C, and 207BK are disposed inside the transport transfer belt 206 opposite the contacts between the photoreceptor drums 201Y, 201M, 201C, and 201BK, respectively, and the transport transfer belt 206. The transfer rollers 207Y, 207M, 207C, and 207BK and the photoreceptor drums 201Y, 201M, 201C, and 201BK, with the transport transfer belt 206 disposed therebetween, form transfer regions where toner images are transferred to a recording medium 216. The transfer rollers 207Y, 207M, 207C, and 207BK may be disposed directly under the photoreceptor drums 201Y, 201M, 201C, and 201BK or may be shifted therefrom.

A fixing device 209 is disposed downstream of the transfer regions between the transport transfer belt 206 and the photoreceptor drums 201Y, 201M, 201C, and 201BK.

A recording medium transport roller 208 transports the recording medium 216 to the transport transfer belt 206.

In the image-forming unit BK, the photoreceptor drum 201BK is rotated. The charging roller 202BK cooperates with the photoreceptor drum 201BK to charge the surface of the photoreceptor drum 201BK to a particular polarity and potential. The charged surface of the photoreceptor drum 201BK is exposed to an image pattern by the exposure device 203BK to form an electrostatic latent image on the surface of the photoreceptor drum 201BK.

The electrostatic latent image is then developed by the black developing device 204BK to form a toner image on the surface of the photoreceptor drum 201BK. The developer may be a one-component developer or two-component developer.

The toner image passes through the transfer region between the photoreceptor drum 201BK and the transport transfer belt 206. The recording medium 216 is electrostatically attracted by the transport transfer belt 206 and is transported to the transfer region. The toner image is transferred to the surface of the recording medium 216 by an electric field generated by a transfer bias applied by the transfer roller 207BK.

The photoreceptor-drum cleaning member 205BK removes residual toner from the photoreceptor drum 201BK, which enters the next image transfer cycle.

This image transfer process is similarly executed by the image-forming units C, M, and Y.

The recording medium 216 having the toner images transferred thereto by the transfer rollers 207Y, 207M, 207C, and 207BK is transported to the fixing device 209, which fixes the toner images.

Thus, an image is formed on the recording medium 216.

### EXAMPLES

The present invention is further illustrated by the following non-limiting examples.

### Example A1

### Preparation of Coating Solution for Forming Substrate Layer

To an N-methyl-2-pyrrolidone (NMP) solution of a polyamic acid that is a polymer of biphenyltetracarboxylic dianhydride (BPDA) and p-phenylenediamine (PDA) (U Imide KX from Unitika Ltd.; solid content: 20% by mass), 18% by mass (solid content) of carbon black (Special Black 4 from Evonik Degussa Japan Co., Ltd.) is added, and the mixture is subjected to dispersion treatment (200 N/mm², five passes) using a jet mill (Geanus PY from Geanus). The resulting carbon-black-dispersed polyamic acid solution is passed through a 20 μm stainless steel mesh to remove foreign matter and aggregated carbon black. The solution is vacuum-degassed with stirring for 15 minutes to yield a final solution (coating solution for forming the substrate layer). Thus, a coating solution for forming the substrate layer is prepared.

### Preparation of Coating Solution for Forming Outermost Layer

### Preparation of Carbon-Black-Dispersed Polyamic Acid Solution

To an N-methyl-2-pyrrolidone (NMP) solution of a polyamic acid that is a polymer of biphenyltetracarboxylic dianhydride (BPDA) and p-phenylenediamine (PDA) (U Imide KX from Unitika Ltd.; solid content: 20% by mass), 15% by mass (solid content) of carbon black (Special Black 4 from Evonik Degussa Japan Co., Ltd.) is added, and the mixture is subjected to dispersion treatment (200 N/mm², five passes) using a jet mill (Geanus PY from Geanus). The resulting carbon-black-dispersed polyamic acid solution is passed through a 20 μm stainless steel mesh to remove foreign matter and aggregated carbon black. The solution is vacuum-degassed with stirring for 15 minutes to yield a final solution (carbon-black-dispersed polyamic acid solution).

### Preparation of Fluoropolymer Particle Dispersion

To 1,000 parts by mass of N-methyl-2-pyrrolidone (NMP), 1,000 parts by mass of PTFE particles having a primary particle size of 0.2 μm and 50 parts by mass of exemplary compound (II-1) (number average molecular weight: 9,100), as a surfactant, are added, and the mixture is stirred at 25° C. for three hours.

Exemplary compound (II-1) is synthesized by a synthesis method disclosed in Japanese Unexamined Patent Application Publication No. 2004-292658.

The mixture is then mixed with 1,000 parts by mass of an N-methyl-2-pyrrolidone (NMP) solution of a polyamic acid that is a polymer of biphenyltetracarboxylic dianhydride (BPDA) and p-phenylenediamine (PDA) (U Imide KX from Unitika Ltd.; solid content: 20% by mass) using a rotary agitator.

The resulting mixed solution is subjected to dispersion treatment (200 N/mm², five passes (three hours)) using a jet mill (Geanus PY from Geanus). The mixed solution is passed through a 20 μm stainless steel mesh to remove foreign matter and aggregated PTFE. The solution is vacuum-degassed with stirring for 15 minutes to yield a final solution (fluoropolymer particle dispersion).

### Preparation of Mixed Solution

A mixture of 3,000 parts by mass of the carbon-black-dispersed polyamic acid solution and 2,000 parts by mass of the fluoropolymer particle dispersion is stirred using a rotary agitator. The mixture is subjected to dispersion treatment (200 N/mm², five passes (three hours)) using a jet mill (Geanus PY from Geanus).

Thus, a coating solution for forming the outermost layer is prepared.

### Fabrication of Endless Belt

A stainless steel (SUS304) cylinder having an outer diameter of 600 mm, a wall thickness of 8 mm, and a length of 900 mm is provided. In addition, discs of the same material are provided as holding plates. The discs have a thickness of 8 mm and an outer diameter that allows the discs to be fitted into the cylinder and have four air vents having a diameter of 150 mm. The discs are fitted into both ends of the cylinder and are welded together to form a core. The outer surface of the core is roughened to a roughness Ra of 0.4 μm by blasting with alumina particles.

A silicone release agent (SEPA-COAT from Shin-Etsu Chemical Co., Ltd.) is then applied to the outer surface of the core and is baked at 300° C. for one hour.

The coating solution for forming the substrate layer is then applied to the outer surface of the core to form a coating of the coating solution for forming the substrate layer.

The coating solution for forming the substrate layer is applied by spiral coating.

The coating conditions are as follows. The coating solution for forming the substrate layer is ejected onto the core at 20 mL/min from a nozzle of a dispenser including a container containing 15 L of the coating solution for forming the substrate layer and a Mohno pump coupled thereto. The core is rotated at 20 rpm. After the ejected coating solution for forming the substrate layer is deposited on the core, a blade is put into contact with the surface of the coating and is moved at a speed of 210 mm/min in the axial direction of the core. The blade is a stainless steel plate having a thickness of 0.2 mm, a width of 20 mm, and a length of 50 mm. The coating width extends from a position 10 mm from one end of the core to a position 10 mm from the other end of the core in the axial direction. After coating, the core is continuously rotated for five minutes to eliminate spiral streaks from the surface of the coating.

Thus, a coating of the coating solution for forming the substrate layer is formed. The coating has a thickness of about 250 μm, which is equivalent to a finished thickness of about 50 μm.

The core is then placed in a drying furnace at 180° C. for 20 minutes while being rotated at 10 rpm to dry the coating of the coating solution for forming the substrate layer. Thus, a film that is to form the substrate layer is formed.

The coating solution for forming the outermost layer is then applied to the surface of the film that is to form the substrate layer to form a coating of the coating solution for forming the outermost layer.

The coating solution for forming the outermost layer is applied in the same manner as the coating solution for forming the substrate layer, where the coating solution is ejected from a nozzle at 40 mL/min, and the coating width extends from a position 10 mm from one end of the core to a position 10 mm from the other end of the core in the axial direction. After coating, the core is continuously rotated for five minutes to eliminate spiral streaks from the surface of the coating.

Thus, a coating of the coating solution for forming the outermost layer is formed. The coating has a thickness of about 250 μm, which is equivalent to a finished thickness of about 50 μm.

The core is then placed in a drying furnace at 185° C. for 30 minutes while being rotated at 10 rpm to dry the coating of the coating solution for forming the outermost layer. Thus, a film that is to form the outermost layer is formed.

The core is then removed from the rotating support, is placed in a vertical position in a heating furnace, and is heated at 200° C. for 30 minutes and 300° C. for 30 minutes to simultaneously facilitate evaporation of residual solvent off the films that are to form the substrate layer and the outermost layer and imidation reaction.

The laminate of the substrate layer and the outermost layer is then removed from the core to obtain an endless belt.

The endless belt is cut in the center thereof in the width direction, and unnecessary portions are cut from both ends thereof to obtain two endless belts having a width of 360 mm. The average thickness of the endless belts measured at 5 locations in the axial direction and 10 locations in the circumferential direction, namely, a total of 50 locations, using a dial gauge is 100 μm.

### Example A2

An endless belt is fabricated as in Example A1 except that the fluoropolymer particle dispersion is prepared using exemplary compound (II-2) (number average molecular weight: 2,400) as a surfactant instead of exemplary compound (II-1).

Exemplary compound (II-2) is synthesized by the synthesis method disclosed in Japanese Unexamined Patent Application Publication No. 2004-292658.

### Example A3

An endless belt is fabricated as in Example A1 except that the fluoropolymer particle dispersion is prepared using exemplary compound (II-3) (number average molecular weight: 4,100) as a surfactant instead of exemplary compound (II-1).

Exemplary compound (II-3) is synthesized by the synthesis method disclosed in Japanese Unexamined Patent Application Publication No. 2004-292658.

### Example A4

An endless belt is fabricated as in Example A1 except that the fluoropolymer particle dispersion is prepared by adding 80 parts by mass of exemplary compound (II-1).

### Example A5

An endless belt is fabricated as in Example A1 except that the fluoropolymer particle dispersion is prepared by adding 30 parts by mass of exemplary compound (II-1).

### Example A6

An endless belt is fabricated as in Example A1 except that the fluoropolymer-particle-dispersed polyamic acid solution is prepared using PFA resin particles having an average primary particle size of 0.2 μm instead of PTFE resin particles.

### Comparative Example A1

An endless belt is fabricated as in Example A1 except that the fluoropolymer particle dispersion is prepared using, instead of exemplary compound (II-1), a fluorinated graft polymer (number average molecular weight: 50,000, l:m=1:1, s=1, n=60) represented by formula (I):

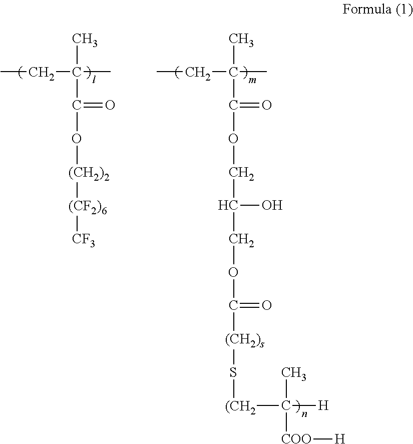

### Comparative Example A2

An endless belt is fabricated as in Example A1 except that, as the carbon-black-dispersed polyamic acid solution used for the coating solution for forming the outermost layer, a carbon-black-dispersed polyamideimide resin solution is prepared using a polyamideimide resin solution (Vylomax 16NN from Toyobo Co., Ltd.; solvent: N-methylpyrrolidone (NMP); solid content: 17% by mass) instead of an N-methyl-2-pyrrolidone (NMP) solution of a polyamic acid (U Imide KX from Unitika Ltd.; solid content: 20% by mass).

### Evaluations

The endless belts thus obtained are evaluated for the following properties.

### Dispersibility of Fluoropolymer Particles in Outermost Layer

The dispersibility of the fluoropolymer particles in the outermost layer is examined as follows.

The outermost layer is observed at 6 locations in the circumferential direction and 3 locations in the axial direction, namely, a total of 18 locations, on the inner surface of the belt under a JSM 6700F field emission scanning electron microscope from JEOL Ltd. at 20,000× magnification with an acceleration voltage of 5 kV. The dispersibility is evaluated according to the following criteria:

G3: The proportion of fluoropolymer particles dispersed as primary particles is less than 90%, and the maximum composite particle size is 2 μm or more.

G2: The proportion of fluoropolymer particles dispersed as primary particles is less than 90%, and the maximum composite particle size is less than 2 μm (within the acceptable limit).

G1: The proportion of fluoropolymer particles dispersed as primary particles is 90% or more.

### Releasability of Outermost Layer

The releasability of the outermost layer is examined as follows.

The water contact angle is measured using a DM-501 water contact angle meter from Kyowa Interface Science Co., Ltd.

The water contact angle is evaluated according to the following criteria:

G3: The water contact angle is less than 90°.

G2: The water contact angle is 90° to less than 100° (within the acceptable limit).

G1: The water contact angle is 100° or more.

### Resistivity Characteristics of Outermost Layer

The resistivity characteristics (decrease in resistivity due to wear) of the outermost layer is examined as follows.

The volume resistivity is calculated from the current measured using a circular probe (UR Probe of HIRESTA IP from Mitsubishi Petrochemical Co., Ltd., outer diameter of cylindrical electrode C: 16 mm, inner diameter of ring electrode D: 30 mm, outer diameter of ring electrode D: 40 mm) at 22° C. and 55% RH after a voltage of 500 V is applied for ten seconds.

The change in resistivity is calculated after 10,000 copies are printed using an image-forming apparatus (DocuColor 8000 Digital Press from Fuji Xerox Co., Ltd.).

The change in resistivity is evaluated according to the following criteria:

G3: The change in resistivity is 0.5 log Ωcm or more.

G2: The change in resistivity is 0.2 to less than 0.5 log Ωcm (within the acceptable limit).

G1: The change in resistivity is less than 0.2 log Ωcm.

### Image Quality

The endless belts are used as an intermediate transfer member (intermediate transfer belt) and are evaluated for image quality as follows.

The intermediate transfer belts are attached to an image evaluation apparatus based on an image-forming apparatus having the basic configuration illustrated in FIG. 5 (DocuColor 8000 Digital Press from Fuji Xerox Co., Ltd.). The second transfer roller is isolated from the power supply built into the evaluation apparatus and is instead connected to an external power supply (Model 610D from TREK Inc.) so that the second transfer roller is externally and directly powered. The transfer voltage applied to the second transfer roller during printing is set to 4.0 kV. A cyan solid (100% density) image is evaluated for extremely small white spots and transfer defects. A cyan halftone (70% density) image is evaluated for flake-like density variations. A cyan halftone (30% density) image is evaluated for HT variations. The image defect with the worst grade is selected for the evaluation grade.

The image defects are evaluated according to the following criteria:

G3: Noticeable image defects are found (far beyond the acceptable limit).

G2: Some image defects are found (within the acceptable limit).

G1: No image defects are found.

The properties and evaluations of the endless belts obtained in the Examples and the Comparative Examples are listed in Table 1.

TABLE 1

| | | Surfactant | | | | | | | |
|---|---|---|---|---|---|---|---|---|---|
| | | | Number | Amount | | | | | |
| | | | average | added | Fluoropolymer | Evaluations | | | |
| | Resin | | molecular | (parts by | particles | | | Resistivity | Image |
| | Type | Type | weight | mass) | Type | Dispersibility | Releasability | characteristics | quality |
| Ex. A1 | Polyimide | (II-1) | 9,100 | 50 | PTFE | G1 | G1 | G1 | G1 |
| Ex. A2 | Polyimide | (II-2) | 2,400 | 50 | PTFE | G2 | G2 | G1 | G2 |
| Ex. A3 | Polyimide | (II-3) | 4,100 | 50 | PTFE | G2 | G1 | G1 | G2 |
| Ex. A4 | Polyimide | (II-1) | 9,100 | 80 | PTFE | G1 | G1 | G1 | G1 |
| Ex. A5 | Polyimide | (II-1) | 9,100 | 30 | PTFE | G1 | G1 | G1 | G1 |
| Ex. A6 | Polyimide | (II-1) | 9,100 | 50 | PFA | G1 | G1 | G1 | G1 |
| Com. | Polyimide | Fluorinated | 50,000 | 50 | PTFE | G3 | G1 | G3 | G3 |
| Ex. A1 | | graft | | | | | | | |
| | | polymer | | | | | | | |
| Com. | Polyamide- | (II-1) | 9,100 | 50 | PTFE | G3 | G1 | G3 | G3 |
| Ex. A2 | imide | | | | | | | | |

### Example B1

An endless belt is fabricated as in Example A1 except that the mixed solution is prepared by dispersion treatment (50 N/mm², three hours) using a jet mill (Geanus PY from Geanus), rather than by dispersion treatment (200 N/mm², five passes (three hours)) using a jet mill (Geanus PY from Geanus).

### Example B2

An endless belt including an outermost layer containing no carbon black is fabricated as in Example A1 except that the mixed solution is prepared using an N-methyl-2-pyrrolidone (NMP) solution of a polyamic acid (U Imide KX from Unitika Ltd.; solid content: 20% by mass) instead of the carbon-black-dispersed polyamic acid solution.

### Example B3

An endless belt is fabricated as in Example 1A except that the coating solution for forming the outermost layer is applied to the outer surface of the core to form a coating of the coating solution for forming the outermost layer, without applying the coating solution for forming the substrate layer to the outer surface of the core.

The coating solution for forming the outermost layer is applied in the same manner as the coating solution for forming the substrate layer in Example A1, where the coating solution is ejected from the nozzle at 80 mL/min, and the coating width extends from a position 10 mm from one end of the core to a position 10 mm from the other end of the core in the axial direction. After coating, the core is continuously rotated for five minutes to eliminate spiral streaks from the surface of the coating.

Thus, a coating of the coating solution for forming the outermost layer is formed. The coating has a thickness of about 500 μm, which is equivalent to a finished thickness of about 100 μm.

The core is then placed in a drying furnace at 185° C. for 30 minutes while being rotated at 10 rpm to dry the coating of the coating solution for forming the outermost layer. Thus, a film that is to form the outermost layer is formed. The remaining procedure is performed as in Example 1A to obtain an endless belt.

### Comparative Example B1

An endless belt is fabricated as in Comparative Example A1 except that the mixed solution is prepared by dispersion treatment (50 N/mm², three hours) using a jet mill (Geanus PY from Geanus), rather than by dispersion treatment (200 N/mm², five passes (three hours)) using a jet mill (Geanus PY from Geanus).

### Evaluations

The endless belts thus obtained are evaluated for the following properties.

### Dispersibility of Fluoropolymer Particles in Outermost Layer

The dispersibility of the fluoropolymer particles in the outermost layer is examined as follows.

The outermost layer is observed at 6 locations in the circumferential direction and 3 locations in the axial direction, namely, a total of 18 locations, on the inner surface of the belt under a JSM 6700F field emission scanning electron microscope from JEOL Ltd. at 20,000× magnification with an acceleration voltage of 5 kV. The dispersibility is evaluated according to the following criteria:

G3: The proportion of fluoropolymer particles dispersed as primary particles is less than 90%, and the maximum composite particle size is 2 μm or more.

G2: The proportion of fluoropolymer particles dispersed as primary particles is less than 90%, and the maximum composite particle size is less than 2 μm (within the acceptable limit).

G1: The proportion of fluoropolymer particles dispersed as primary particles is 90% or more.

### Releasability of Outermost Layer

The releasability of the outermost layer is examined as follows.

The water contact angle is measured using a DM-501 water contact angle meter from Kyowa Interface Science Co., Ltd.

The water contact angle is evaluated according to the following criteria:

G3: The water contact angle is less than 90°.

G2: The water contact angle is 90° to less than 100° (within the acceptable limit).

G1: The water contact angle is 100° or more.

### Image Quality

The endless belts are used as an intermediate transfer member (intermediate transfer belt) and are evaluated for image quality as follows.

The intermediate transfer belts are attached to an image evaluation apparatus based on an image-forming apparatus having the basic configuration illustrated in FIG. 5 (DocuColor 8000 Digital Press from Fuji Xerox Co., Ltd.). The second transfer roller is isolated from the power supply built into the evaluation apparatus and is instead connected to an external power supply (Model 610D from TREK Inc.) so that the second transfer roller is externally and directly powered. The transfer voltage applied to the second transfer roller during printing is set to 4.0 kV. A cyan solid (100% density) image is evaluated for extremely small white spots and transfer defects. A cyan halftone (70% density) image is evaluated for flake-like density variations. A cyan halftone (30% density) image is evaluated for HT variations. The image defect with the worst grade is selected for the evaluation grade.

The image defects are evaluated according to the following criteria:

G3: Noticeable image defects are found (far beyond the acceptable limit).

G2: Some image defects are found (within the acceptable limit).

G1: No image defects are found.

The properties and evaluations of the endless belts obtained in the Examples are the Comparative Example are listed in Table 2.

TABLE 2

| | | Surfactant | | | | | | |
|---|---|---|---|---|---|---|---|---|
| | | | | Amount | Fluoropolymer | Evaluations | | |
| | Resin | | Number average | added (parts | particles | | | Image |
| | ype | Type | molecular weight | by mass) | Type | Dispersibility | Releasability | quality |
| Ex. B1 | Polyimide | (II-1) | 9,100 | 50 | PTFE | G2 | G1 | G2 |
| Ex. B2 | Polyimide | (II-1) | 9,100 | 50 | PTFE | G1 | G1 | G3 |
| Ex. B3 | Polyimide | (II-1) | 9,100 | 50 | PTFE | G1 | G1 | G1 |
| Com. Ex. | Polyimide | Fluorinated | 50,000 | 50 | PTFE | G3 | G1 | G3 |
| B1 | | graft polymer | | | | | | |

The above results demonstrate that the Examples are superior to the Comparative Examples in terms of the dispersibility of the fluoropolymer particles in the outermost layer, the releasability of the outermost layer, and image quality. The results also demonstrate that the Examples show a smaller decrease in resistivity due to wear of the outermost layer than Comparative Example A2.

Example B2 shows slight density variations after continuous printing in the image quality evaluation.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide resin film comprising a layer containing a polyimide resin, fluoropolymer particles, and a compound represented by general formula (II) or a laminate of two or more layers including the layer as an outermost layer: 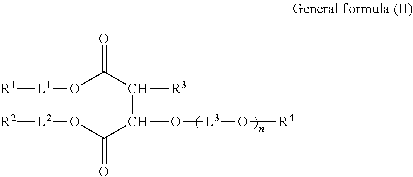
(wherein R¹ and R² are each independently a fully fluorinated linear or branched alkyl or a partially fluorinated linear or branched alkyl; R³ is hydrogen, methyl, or ethyl; R⁴ is hydrogen or a linear or branched alkyl; L¹ and L² are each independently a single bond or a linear or branched alkylene; L³ is a linear or branched alkylene; and n is an integer of about 5 to about 500).

2. The polyimide resin film according to claim 1, wherein the compound represented by general formula (II) has a number average molecular weight of about 1,000 to about 30,000.

3. A substantially tubular member comprising the polyimide resin film according to claim 1.

4. A tubular member unit attachable to and detachable from an image-forming apparatus, the tubular member unit comprising:
the tubular member according to claim 3; and
a plurality of rollers about which the tubular member is entrained.

5. An intermediate transfer member comprising the tubular member according to claim 3.

6. An image-forming apparatus comprising:
an image carrier having a surface;
a charging unit that charges the surface of the image carrier;
a latent-image forming unit that forms a latent image on the surface of the image carrier;
a developing unit that develops the latent image on the surface of the image carrier with a toner to form a toner image;
the intermediate transfer member according to claim 5, the intermediate transfer member having a surface to which the toner image is transferred from the surface of the image carrier;
a first transfer unit that transfers the toner image from the surface of the image carrier to the surface of the intermediate transfer member;
a second transfer unit that transfers the toner image from the surface of the intermediate transfer member to a recording medium; and
a fixing unit that fixes the toner image to the recording medium.

7. A method for forming an image, comprising:
charging a surface of an image carrier;
forming a latent image on the surface of the image carrier;
developing the latent image on the surface of the image carrier with a toner to form a toner image;
transferring the toner image from the surface of the image carrier to a surface of the intermediate transfer member according to claim 5;
transferring the toner image from the surface of the intermediate transfer member to a recording medium; and
fixing the toner image to the recording medium.
